(19) United States
(12) Patent Application Publication
(10) Pub. No.: US 2007/0176738 A1
(43) Pub. Date: Aug. 2, 2007

(54) ACTUATION CONTROL

(75) Inventor: Gregory Douglas Horler, Huddersfield (GB)

Correspondence Address: GAUTHIER & CONNORS, LLP, 225 FRANKLIN STREET, SUITE 2300, BOSTON, MA, 02110, US

(73) Assignee: INSTRUMENTEL LIMITED, West Yorkshire (GB)

(21) Appl. No.: 11/672,360

(22) Filed: Feb. 7, 2007

Related U.S. Application Data
(63) Continuation of application No. PCT/GB05/03129, filed on Aug. 10, 2005.

(30) Foreign Application Priority Data
Aug. 10, 2004 (GB) GB0417789.5

(51) Int. Cl. G05B 19/00

(52) U.S. Cl. 340/5.61; 340/5.73; 340/5.26

(57) ABSTRACT

An actuation control system is disclosed that includes an actuator that is operatively associated with an actuator device, and a key for operating the actuator. The actuator and the key are arranged in use to be wirelessly coupled, and the actuator is arranged in use to derive the electrical energy for actuating the device from the key.

### PRIORITY

This application is a continuation application of Patent Cooperation Treaty application PCT/GB2005/003129 filed Aug. 10, 2005, which claims priority to GB Application No. 0417789.5 filed on Aug. 10, 2004.

### BACKGROUND

The present invention relates to actuation control and is concerned particularly though not exclusively with actuation control for a lock-and-key system which enables access to a lockable article to be controlled securely.

Lock-and-key mechanisms for controlling access, such as access to a space or to the interior of a container, have developed in recent years to include electronic identification techniques, wherein the key is provided with an identification code, stored electronically or magnetically, which the lock is designed to read and recognize when the two are brought into proximity. The lock is arranged to permit actuation from a locked condition to an unlocked condition or vice-versa only when an approved key, i.e., a key with an authorized identification code, is used. Typically, the reading device is contained in the locking means or else in a lockable closure member itself, such as a lid or door, with which the locking means is operatively engaged. The reader requires electrical power in order to detect and process the identification code of the key, for example when the key is swiped through or pressed against the reader in the case of a magnetic-strip-type key card, or else when the key is made to transmit a radio or infrared (IR) signal to the locking means, in the case where the key comprises a battery-powered transmitter.

One disadvantage with such prior arrangements arises from the need for the reader—and therefore the locking means—to have its own electrical power source. Either the locking means must have a connection to primary electricity source, which means that it, and therefore the article with which it is associated, is not fully portable, or else it must have a battery, which will inevitably become discharged in time and which will require replacement.

Another limitation in the functionality of most of the known systems of the kind described above is that, whilst the lock and key mechanisms do interact, the interaction is very simple and typically constitutes a single event in which the locking mechanism reads the identification code stored in the card and either permits or denies actuation of the locking means accordingly.

One example of an exception to the above is to be found in hotel room doors, where a hard-wired network connects all of the locking mechanisms and a central control is able to derive data from individually addressable doors to identify, for example, instances of attempted entry with an unauthorized key. However, the hard-wired system described above prevents the articles—in this case the doors—from being fully portable. Whilst this is not a problem for a hotel room door-locking mechanism it does mean that this facility is not practical for use with articles which must be transported, such as portable containers, for example.

### SUMMARY

The present invention aims to address the aforementioned problems. In accordance with an embodiment, the invention provides an actuation control system that includes an actuator that is operatively associated with an actuator device, and a key for operating the actuator. The actuator and the key are arranged in use to be wirelessly coupled, and the actuator is arranged in use to derive the electrical energy for actuating the device from the key.

In one aspect the present invention provides an actuation control system comprising: an actuator, operatively associated with an actuatable device, and a key for operating the actuator, wherein the actuator and the key are arranged in use to be wirelessly coupled, and wherein the actuator is arranged in use to derive electrical energy for actuating the device from the key.

Preferably the actuator and the key are arranged in use to be inductively coupled in use. The device may comprise a locking means or a sensor means.

In a preferred embodiment the key is arranged in use to transmit an authorization code to the actuator, wherein the actuator is arranged to actuate the device only if the authorization code transmitted by the key is recognized by the actuator as an approved code.

The key means may comprise a source of electrical power, and may comprise first electronic processing means. The actuator may comprise second electronic processing means.

In a particularly preferred embodiment, the actuator is arranged to transmit a signal to the key, which signal may comprise an identification signal and/or data, such as data from the device.

The device may comprise locking means which may be operably associated with a closure member of an article.

Preferably the locking means comprises at least one lock member capable of adopting a first configuration in which the closure member is locked with respect to the article, and a second configuration in which the closure member is unlocked with respect to the article, wherein the locking means is arranged to use the derived electrical power to effect configuration change of the or each lock member.

Preferably the actuator is arranged to derive electrical power from incident electromagnetic radiation transmitted by the key when the key and the actuator are in appropriate proximity.

Preferably the first and/or second processing means comprises digital processing means.

Preferably the key means comprises a primary induction coil and the actuator comprises a secondary induction coil, whereupon electrical power is obtained by the actuator from the key by inductive coupling of the primary and secondary coils.

Preferably the key comprises first transceiver means and the actuator comprises second transceiver means, whereby the key and actuator are operatively arranged for two-way communication therebetween.

Preferably the actuator and/or the key comprise at least one sensor means which is arranged in use to detect, measure or monitor a parameter.

The actuator and/or the key may include one or more electronic memory devices which may be arranged to store data.

The or each electronic memory device may be arranged to store data from the actuator means and/or the key.

The or each electronic memory device may be arranged to store data including data corresponding to one or more parameters which have been detected, measured or monitored by the or each sensor means.

The or each electronic memory device may be arranged to store data which includes a transaction history of transactions between the key means and the actuator or between other keys and the actuator.

The invention also provides a method of controlling actuation of a device, the method comprising bringing into proximity a key and an actuator, transmitting an electronic signal from the key to the actuator from which the actuator derives electrical power, and actuating the device.

Preferably the method also includes transmitting at least one identification signal from the key to the actuator which identification signal is recognized by the actuator.

The invention also provides a key for use in controlling an actuator for a device, the key comprising a source of electrical power and means for transmitting a signal to an actuator, which signal may be used by the actuator to derive electrical power for actuating the device.

The invention also provides an actuator, the actuator comprising means to derive electrical power from an electrical signal transmitted by a key, for actuating a device.

The actuator may also include means to derive an identification signal of the key from an electrical signal transmitted by the key.

The invention may include any combination of the features or limitations referred to herein except combinations of such features as are mutually exclusive.

### BRIEF DESCRIPTION OF THE ILLUSTRATED EMBODIMENTS

Embodiments of the present invention will now be described by way of example only with reference to the accompanying drawings in which;

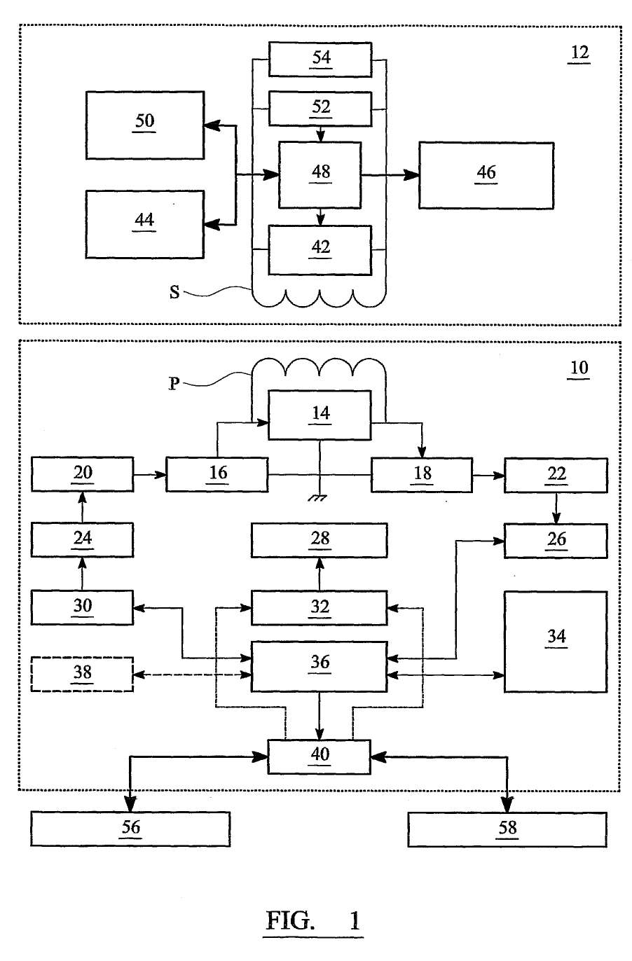

FIG. 1 is a schematic representation of a system for controlling the operation of a lockable closure member, according to an embodiment of the invention,

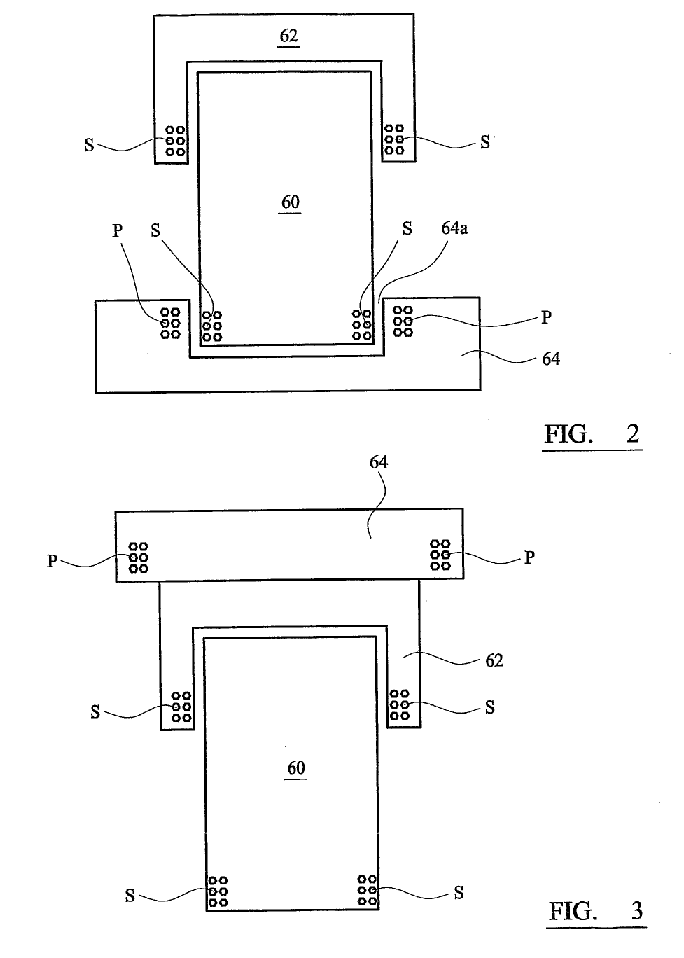

FIG. 2 shows schematically a container and closure member incorporating an actuation control system in accordance with a first embodiment of the invention,

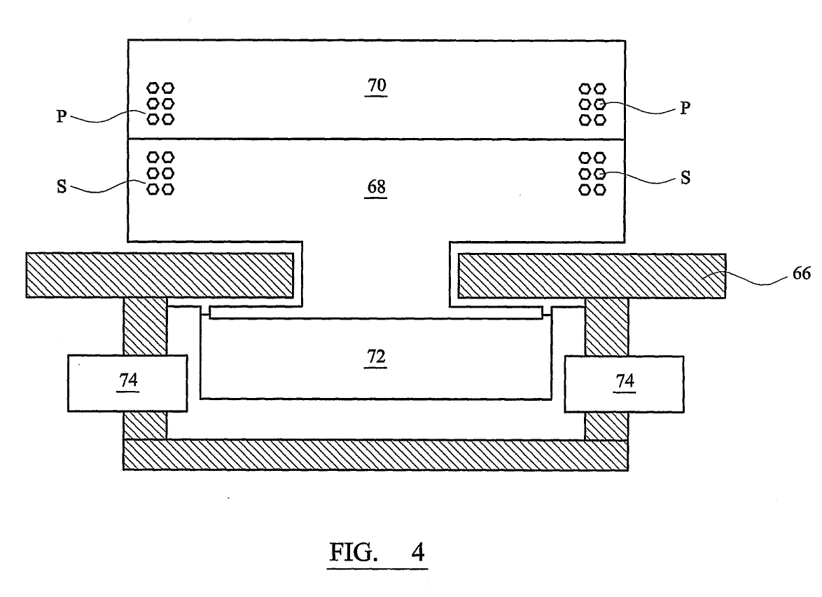

FIG. 3 shows schematically a container and closure member incorporating an actuation control system in accordance with a second embodiment of the invention, and

FIG. 4 shows schematically a container and closure member incorporating an actuation control system in accordance with a third embodiment of the invention

### DETAILED DESCRIPTION OF THE ILLUSTRATED EMBODIMENTS

Systems for providing two-way electronic communication between a base station and a remote station in which the remote station is able to derive electrical power, necessary for its function, from incident electromagnetic radiation transmitted by the base station, are disclosed in PCT patent publication number WO 2003/065326, the entire disclosure of which is hereby incorporated by reference.

In accordance with an embodiment, an actuation control system and method are disclosed that utilize wireless coupling of a key and an actuator to effect actuation of a device such as a lock or sensor. Turning to FIG. 1, this shows schematically a system for securely controlling the operation of a closure member (not shown) such as a door of a container.

The system comprises a key shown generally at 10 and an actuator, in this case comprising a lock actuator shown generally at 12. In this embodiment, the key 10 includes a primary coil P, a resonant filter 14, a power amplifier 16, a filter 18, a modulator 20 and demodulator 22, an encryption unit 24 and decryption unit 26, a rechargeable power pack 28, a memory device 30, a power circuit 32, a GPS (Global Positioning Satellite) device 34, a controller 36, an LCD display 38 and an interface device 40.

The lock actuator 12 comprises a secondary coil S, a combined resonant filter and modulator 42, a memory device 44, a locking device 46, a controller 48, a sensor 50, a demodulator 52 and a power circuit 54.

In use, the lock actuator 12 is arranged to be integral with, mounted on or attached to a closure member such as a door of a container, for example. The key 10 may be portable, or else maybe fixed to or integral with a key station (not shown).

When the key 10 is brought into sufficiently close proximity to the lock actuator 12 (dependent upon the specific circuitry and power available) the primary coil P of the key 10 and the secondary coil S of the lock actuator 12, which are tuned for resonance by the resonant filters 14 (of the key) and 42 (of the lock actuator), become inductively coupled. If the key 10 is authorized, it may be used to effect actuation of the lock, thereby to gain access to the container, with power being derived by the actuator from the key, through their wireless coupling.

In the key 10 an oscillator (not shown) generates an electrical carrier signal which is amplitude-modulated by the modulator 20 and amplified by the power amplifier 16.

This modulated signal becomes transmitted by the key 10 via the primary coil P and is received at the lock actuator 12 via the inductive coupling by the secondary coil S.

As will be described below, the modulated carrier signal from the key provides both electrical power and information, such as identification data and commands, to the lock actuator 12. The lock actuator 12 uses the electrical power received from the key for its own operations.

When the key 10 and lock actuator 12 are brought into proximity, so that inductive coupling takes place, the lock actuator receives the signal transmitted from the key. In the lock actuator 12 the power circuit 54 rectifies and smoothes the carrier signal to provide power to the lock actuator 12 and the demodulator 52 demodulates the signal to derive data and control commands.

When the lock actuator becomes activated, i.e., begins to receive power from the key, a hand-shake protocol is initiated between the lock actuator and the key. Typically this will include the generation by the lock actuator of an encryption key, which will be used to encrypt subsequent communication between the key and the lock actuator.

In this example, in the lock actuator, the encryption and decryption of signals communicated between the lock actuator and the key takes place in the controller 48. In the key, encryption and decryption are carried out respectively by the units 24 and 26.

Stored in memory 44 of the lock actuator is a plurality of identification/access codes. One such code is required merely to activate the circuitry of the lock actuator, whereas other codes relate to different functions of the lock actuator, such as reading data from the sensor 50, reading transaction or other data stored in the memory 44, or activating the locking device 46.

In the key, the memory 30 may contain one or more of the identification/access codes, or else the key 10 may obtain these via a network, which may be a WiFi network for example, in real time. In the initial hand-shake protocol between the lock actuator and the key, the lock actuator asks the key for an identification signal and then compares the response with stored information. Similarly the lock actuator identifies itself to the key, which then examines its own stored records. The point of this process is to determine whether communication between the key and lock actuator has been authorized—i.e., whether the key is making legitimate contact with the lock actuator.

If either the controller 48 of the lock actuator does not recognize the identification signal of the key, or else the controller 36 of the key does not recognize the identification of the signal from the lock actuator, then communication between the lock and key will be terminated. In this case the lock actuator and/or the key will store in their respective memories appropriate transaction records which will log, amongst other things, the time of the attempted communication and the identification of the key.

On the other hand, if the respective controllers of the lock actuator and key satisfy themselves that communication is authorized, then the two-way communication between them may continue.

One example of a legitimate transaction between the lock and the key is the actuation of a locking device (46) so as to lock or unlock a closure member (not shown) of a container (not shown).

In such a transaction, after initial protocols have approved the activity, the key will send an encrypted access code to the lock actuator which code is either stored in memory 30 or else is obtained via a network, and which code corresponds to an OPERATE LOCKING DEVICE command.

Upon receipt of the access code the controller 48 will decrypt the received code and compare the code with the stored codes in its memory 44. If the code is correct then the controller will send a signal to the locking device 46 which includes driving circuits to effect actuation of the locking device, and so to lock or unlock a closure member as desired.

Once the actuation of the locking device is completed, a transaction log of the event will be stored by the lock actuator in its memory 44.

Another example of a legitimate transaction is the reading of data obtained from the sensor 50, which may, for example, be a temperature sensor arranged to monitor the temperature inside the container (not shown). In this case a different encrypted access code will be sent by the key to the lock actuator. If the code is recognized by the lock actuator the controller 48 of the lock actuator will encrypt the data which may come directly from the sensor after conditioning therein (in the case of current data) or else may come from the memory 44 (in the case of stored data). The encrypted data is then used to amplitude-modulate the carrier signal in the filter-modulator unit 42 and is transmitted via the inductive coupling to the key, where after filtering, demodulation and decryption it is obtained by the controller 36. The controller 36 may display the data on display 3 8 and/or may store it in memory 30. The data may be transmitted to other locations/devices via a network.

Again, at the completion of the transaction the lock actuator stores a record in its memory 44.

Another example of legitimate transaction between the key and the lock actuator includes the downloading by the key of the transaction history stored in the memory 44 of the lock actuator.

The key has an interface 40 which may enable the key to communicate via a hard-wired interface or else via a wireless interface, such as an inductively coupled interface, with other devices/locations. The GPS module maybe used to identify the position of the key at all times.

The use of a WiFi or other wireless network may allow a filly portable key to be used in only certain physical locations, such as a particular area of a stockyard for example.

The sensor 50 could be one of a plurality of such sensors, wherein each is arranged in use to detect, measure or monitor a different parameter associated with the article, container of vessel with which the lock actuator is associated.

The rechargeable powerpack 2 8 of the key 10 maybe recharged by a physical, i.e. ohmic, connection such as via interface 56, or else maybe recharged by a indirectly coupled connection such as via interface 58.

The key 10 could be fully portable, partially portable with an attached cable for power and/or data in/out or else could be fixed, for example in a particular location such as part of a store room or warehouse or on a workbench, in which the case the lock actuator, and therefore the article with which it is associated, would have to be brought to the key in order for the two to become inductively coupled.

FIG. 2 shows in schematic sectional view a container (pot) 60 with a lockably removable lid 62 and a key station 64 which may be embedded in a workbench (not shown).

The key station includes a recess 64a which is of such a size and shape as to accommodate a portion of the container 60. The key station contains the elements of the key 10 described above in relation to FIG. 1. With the exception of primary coil P those elements are omitted from the figure in the interests of clarity.

Each of the container 60 and its removable lockable lid 62 incorporates the elements of the lock actuator 12 as described in relation to FIG. 1. In the interest of clarity, only the secondary coils S of the two sets of elements making up the lock actuators 12 are shown.

In order to lock or unlock the lid 62 the container 60 and lid 62 must be placed in the recess 64a of the key station 64 on the workbench (not shown). Once the container and lid are in the positions shown, the key in the key station will be able to enter into two-way communication with each of the container 60 and lid 62 in a manner such as is described above in relation to FIG. 1, due to the inductive coupling between the primary coil P and each of the secondary coils S.

Each of the key in the key station 64, the lock actuator in the container 60 and the lock actuator in the lid 62 has its own identification code. When communication is legitimate, i.e. when the identification codes of each is acceptable to the other, then locking/unlocking of the lid as well as downloading of sensor data from the container or transaction history from either of the container 60 or lid 62 may take place.

The arrangement shown schematically in FIG. 2 enables access to the container to be securely controlled. It also may prevent incorrect pairing of lids with containers when contamination would otherwise result.

FIG. 3 shows in schematic cross section a similar arrangement to that described in FIG. 2, with the exception that in the FIG. 3 example the key is a portable key. Again, the key has the elements of the key 10 described in relation to FIG. 1 and each of the container 60 and lid 62 has the elements of the lock actuator 12 described in relation to FIG. 1.

FIG. 4 shows in schematic cross section a container 66 having an outer lock actuator 68 which has the elements of the lock actuator 12 of the FIG. 1 example and a portable key 70 which has the elements of the key 10 of the FIG. 1 example. In this embodiment, once authorized actuation of the actuator (not shown) of the lock actuator 68 has taken place the operation of an inner lock actuator 72, enabled by the operation of the outer lock actuator 68, must take place before access to the container 66 is possible.

The operation of the inner lock actuator 72 may require mechanical, electronic or electromechanical activity, for example so as to operate a latching mechanism 74. In a simple example an operative (not shown) is required to manually engage and operate the latching mechanism 74 to gain access to the container. Nevertheless, the operation of the latching mechanism and therefore of the inner lock actuator 72 is only enabled once, the outer electronic lock actuator 68 has been operated, following legitimate authorized use of the key 70 in the manner described in relation to the FIG. 1 example.

The invention thus provides a number of options for controlling the operation of a locking closure member. In addition to requiring appropriate electronic authorizing codes, the successful operation of the lock actuator may be required to take place only at a certain location and/or a certain time, for example.

The distribution of authorizing identification/access codes may be controlled securely by a network or for example via the internet, and fees maybe charged to a user of this service accordingly.

Detailed transaction histories may be obtained for each container, so that a legitimate user of the system may learn of unauthorized attempts to open the containers.

No electrical power supply is required for the container, neither is a battery needed, since all of the power needed for the lock to operate may be obtained from the key. Therefore the containers are fully portable and require no recharging or replacement of batteries.

Although inductive coupling is given above as the preferred example of indirect coupling between the key and the actuator, the skilled person will be aware that other possibilities exist such as capacitive coupling, for example.

In the above examples the actuator has comprised a lock actuator for actuating a locking device and/or a sensor device. Those skilled in the art will appreciate that the actuator could be arranged in use to actuate many different types of device, including but not limited to, switches, radiation sources and pumps as well as various types of locking and sensing devices.

In addition, the actuator itself may be of a type which is arranged to effect actuation in a number of different ways including, but not limited to, electrically, electromagnetically, electromechanically, electrochemically, mechanically, electronically, piezo-electrically, optically or a combination of the above.

1. An actuation control system comprising:
an actuator, operatively associated with an actuatable device, and a key for operating the actuator,
wherein the actuator and the key are arranged in use to be wirelessly coupled, and wherein the actuator is arranged in use to derive electrical energy for actuating the device from the key.

2. A system according to claim 1, wherein the actuator and the key are arranged in use to be inductively coupled.

3. A system according to claim 1 wherein the device comprises a locking means or a sensor means.

4. A system according to claim 1 wherein the key is arranged in use to transmit an authorization code to the actuator, wherein the actuator is arranged to actuate the device only if the authorization code transmitted by the key is recognized by the actuator as an approved code.

5. A system according to any of claims claim 1 wherein the key comprises a source of electrical power.

6. A system according to claim 1 wherein the key compromises first electronic processing means.

7. A system according to claim 1 wherein the actuator comprises second electronic processing means.

8. A system according to claim 1 wherein the actuator is arranged to transmit a signal to the key, which signal may comprise an identification signal and/or data, such as data from the device.

9. A system according to claim 1 wherein the device comprises locking means which may be operably associated with a closure member of an article.

10. A system according to claim 9 wherein the locking means comprises at least one lock member capable of adopting a first configuration in which the closure member is locked with respect to the article, and a second configuration in which the closure member is unlocked with respect to the article, wherein the locking means is arranged to use the derived electrical power to effect configuration change of the or each lock member.

11. A system according to claim 1 wherein the actuator is arranged to derive electrical power from incident electromagnetic radiation transmitted by the key when the key and the actuator are in appropriate proximity.

12. A system according to claim 6 wherein one of the key and the actuator comprises digital processing means.

13. A system according to claim 1 wherein the key means comprises a primary induction coil and the actuator comprises a secondary induction coil, whereupon electrical power is obtained by the actuator from the key by inductive coupling of the primary and secondary coils.

14. A system according to claim 1 wherein the key comprises first transceiver means and the actuator comprises second transceiver means, whereby the key and actuator are operatively arranged for two-way communication therebetween.

15. A system according to claim 1 wherein one of the key and the actuator comprises at least one sensor means which is arranged in use to detect, measure or monitor a parameter.

16. A system according to claim 1 wherein at least one of the key and the actuator includes at least one electronic memory device which may be arranged to store data.

17. A system according to claim 16 wherein the, or each, electronic memory device may be arranged to store data from at least one of the actuator means and the key.

18. A system according to claim 16 wherein the electronic memory device is arranged to store data including data corresponding to at least one parameter which has been detected, measured or monitored by the sensor means.

19. A system according to claim 16 wherein the electronic memory device is arranged to store data which includes a transaction history of transactions between the key and the actuator or between other keys and the actuator.

20. A method of controlling actuation of a device, the method comprising bringing into proximity a key and an actuator, transmitting an electronic signal from the key to the actuator from which the actuator derives electrical power, and actuating the device.

21. A method according to claim 20 wherein the method also includes transmitting at least one identification signal from the key to the actuator which identification signal is recognized by the actuator.

22. A key for use in controlling an actuator for a device, the key comprising a source of electrical power and means for transmitting a signal to an actuator, which signal may be used by the actuator to derive electrical power for actuating the device.

23. An actuator for actuating a device, the actuator comprising means to derive electrical power from an electrical signal transmitted by a key, to actuate the device.

24. An actuator according to claim 23 wherein the actuator also includes means to derive an identification signal of the key from an electrical signal transmitted by the key.
